(19) United States
(12) Patent Application Publication
(10) Pub. No.: US 2026/0261456 A1
(43) Pub. Date: Sep. 3, 2026

(54) TRAINABLE JOINT CHANNEL ESTIMATION, DETECTION AND DECODING METHOD SUITABLE FOR URLLC-MIMO SYSTEM

(71) Applicant: Southeast University, Nanjing (CN)

(72) Inventors: Hong SHEN, Nanjing (CN); Yi SUN, Nanjing (CN); Wei XU, Nanjing (CN); Pengcheng ZHU, Nanjing (CN); Chunming ZHAO, Nanjing (CN)

(21) Appl. No.: 19/165,328

(22) PCT Filed: May 23, 2023
(86) PCT No.: PCT/CN2023/095913

§ 371 Date: Sep. 15, 2025

(30) Foreign Application Priority Data
May 10, 2023 (CN) 202310521099.9

(51) Int. Cl. H04L 25/02; G06N 3/08; H04B 7/0413; H04L 1/00

(52) U.S. Cl. CPC H04L 25/0254; G06N 3/08; H04B 7/0413; H04L 1/0055; H04L 1/0058

(57) ABSTRACT

Provided in the present invention is a trainable joint channel estimation, detection and decoding method suitable for a URLLC-MIMO system. In a URLLC-MIMO system, after mapping an LDPC codeword into modulation symbols, a transmitting end uniformly allocates the modulation symbols to different transmitting antennas for transmission; and a receiving end constructs a joint channel estimation, detection and decoding problem model and solving frame based on an MAP criterion, then deeply unfolds the frame into a neural network, performs offline training on adjustable parameters in the neural network, and finally uses the trained neural network to acquire codeword bits online. Compared with a traditional reception method, by means of the present invention, the BLER performance of a system can be significantly improved, and system latency is also reduced, thereby saving on signaling overheads.

### TECHNICAL FIELD

The present disclosure relates to the field of the wireless communication, and especially relates to a trainable joint channel estimation, detection and decoding method applicable to a URLLC (ultra-reliable and low-latency communication)-MIMO (multi-input multi-output) system.

### BACKGROUND

In order to support the new services such as the telemedicine and industrial automation, the fifth generation of mobile communications (5G) has generated a new communication scenario-Ultra-Reliable Low-Latency Communications (URLLC). In order to satisfy the stringent low-latency requirements of URLLC, a short packet transmission scheme is generally adopted by the system. On the other hand, MIMO (Multiple-Input Multiple-Output) technology can improve the transmission reliability of the system by utilizing the spatial redundancy. Therefore, the short packet MIMO transmission has gradually attracted attention. However, the existing research work mainly focuses on the theoretical performance analysis under the limited code length. In consideration with the research on the receiving algorithms of the URLLC-MIMO system is relative few, and the decoding capability of the error correction codes with shorter code length is limited, which also brings the challenges to the design of the receiver.

The traditional turbo receivers improve the performance by exchanging the additional information between the different modules, and have been successfully applied to the long LDPC (Low Density Parity Check) coded systems. However, in consideration that the short code encoding is required to be adopted in the short packet transmission, and the short cycle is generated in the Tanner graph of the short LDPC code, so that the unfavorable positive feedback is generated in the BP decoding, which causes the error propagation in the turbo iterations and causes the performance impairment. On the other hand, in order to ensure the transmission efficiency of short packets, the pilot length is generally limited, which also limits the performance of the pilot-based channel estimation, thereby affecting the performance of the overall system. In addition, a non-negligible latency is caused by the interaction between the turbo receiver modules, which does not satisfy the requirements of the URLLC.

### SUMMARY

Technical problem to be solved by the present disclosure: the objectives of the present disclosure are to provide a trainable joint channel estimation, detection and decoding method applicable to a URLLC-MIMO system, so as to avoid the performance loss and the error propagation caused by the module division, significantly improve the block error rate (BLER) performance of the system, reduce the system latency and save the signaling overheads.

In order to solve the above-mentioned technical problems, the technical solutions provided in the present disclosure are specifically as follows.

Provided is a trainable joint channel estimation, detection and decoding method applicable to a URLLC-MIMO system. A URLLC-MIMO system is considered in the method, after an LDPC codeword is mapped into modulation symbols by a transmitting terminal, the modulation symbols are evenly allocated to different transmitting antennas for transmitting. A joint channel estimation, detection and decoding problem model as well as a solution framework based on a MAP criterion are constructed by the receiving terminal, and the solution framework is then deeply unfolded into a neural network, and the adjustable parameters in the neural network are trained offline. Finally, the trained neural network is utilized at the receiving terminal to acquire the codeword bits. The steps are specifically as follows.
(1) A joint channel estimation, detection and decoding problem model, as well as a solution framework are constructed based on a MAP criterion.
(2) A neural network that unfolds the solution framework for the joint channel estimation, detection and decoding problem is established, and the adjustable parameters in the solution framework are set as the trainable parameters of the neural network.
(3) In an offline phase, data sets required for training are generated, and the neural network is trained, and the trainable parameters are obtained.
(4) In an online phase, an output of each layer of a network is determined by a receiving terminal through utilizing a trained neural network, when check equations are satisfied, a processing is terminated in advance, and a current determination is output, otherwise, a determination corresponding to an output of a last layer of the network is output.

Further, in the trainable joint channel estimation, detection and decoding method applicable to the URLLC-MIMO system, it is assumed that Nₜ transmitting antennas and Nᵣ receiving antennas are configured in the URLLC-MIMO system, and a channel coefficient is kept constant within a transmission time slot of T_{P}+T_{D} symbols, where T_{P} denotes the number of pilot symbols, and T_{D} denotes the number of data symbols. In the data transmission phase, firstly, information bits are encoded into an LDPC codeword b=[b₁, b₂, . . . , b_{N}]^{T} with a code length of N by a transmitting terminal. Let H∈[0,1]^{M×N} represent a binary check matrix of the LDPC code, where M denotes the number of the check nodes. Subsequently, the codeword is mapped into modulation symbols x=[x₁, x₂, . . . , x_{N/Q}]^{T} by the transmitting terminal, and the modulation symbols are evenly allocated to Nₜ transmitting antennas for transmission by utilizing a multi-stream multiplexing technology, where Q denotes a modulation order. The pilot matrix is recorded as P [symbol] ^{N}^{ₜ}^{×T}^{_{P}}, and the data matrix is recorded as D∈ [symbol] ^{N}^{ₜ}^{×T}^{_{D}}, where T_{D}=N/(Q×Nₜ), and the receiving signal can be represented as:

$$[ {Y}_{P} , {Y}_{D} ] = G [ P , D ] + N ,$$

where Y_{P}∈ [symbol] ^{N}^{ₜ}^{×T}^{_{P}} denotes a pilot receiving matrix, and Y_{D}∈ [symbol] ^{N}^{ₜ}^{×T}^{ₚ} denotes a data receiving matrix, G∈ [symbol] ^{N}^{ᵣ}^{×N}^{ₜ} denotes a Gaussian channel matrix, and each element in the Gaussian channel matrix is independently and identically distributed, and a mean value of the each element in the Gaussian channel matrix is 0 and a variance of the each element in the Gaussian channel matrix is 1, N∈ [symbol] ^{N}^{ᵣ}^{×(T}^{_{P}}^{+T}^{_{D}}⁾ denotes an additive white Gaussian noise matrix, and each element in the additive while Gaussian noise matrix is independently and identically distributed, a mean value of the each element in the additive while Gaussian noise matrix is 0 and a variance of the each element in the additive while Gaussian noise matrix is σ². Given that the (k, t)-th element in D is in correspondence to a modulation symbol x_{N}_{ₜ}₍ₜ₋₁₎₊ₖ. In addition, for the convenience of the subsequent representation, D is recorded as f(b), and f(⋅) denotes a bit-symbol mapping function, and a vectorized form of Y_{P} is recoded as y_{P}, a vectorized form of Y_{D} is recorded as y_{D}, and a vectorized form of G is recorded as g.

Further, in Step (1), a joint channel estimation, detection and decoding problem model based on a maximum a posteriori (MAP) criterion is constructed as follows: an optimization object is:

$${min}_{g ∈ {C}^{{N}_{r} {N}_{t} \times 1} , b ∈ {\{ 0.1 \}}^{N \times 1}} {‖ {[ {y}_{P}^{T} , {y}_{D}^{T} ]}^{T} - ( {[ P , f ( b ) ]}^{T} ⊗ {I}_{{N}_{r}} ) g ‖}_{2}^{2} + {σ}^{2} {‖ g ‖}_{2}^{2} ,$$

a constraint is:

$${[ {\sum }_{i = 1}^{N} {H}_{ji} {b}_{i} ]}_{2} = 0 , j = 1 , 2 , … , M ,$$

$${b}_{i} ∈ \{ 0 , 1 \} , i = 1 , 2 , … , N ,$$

where [⋅]₂ denotes a modular-2 operator, I_{N}_{_{P}} denotes an identity matrix with a dimension Nᵣ×Nᵣ, and H, denotes the (j,i)-th element in the check matrix H of the LDPC code.

Further, in Step (1), an original problem is rewritten into a following form, an optimization object is

$${min}_{g ∈ {C}^{{N}_{r} {N}_{i} / 1} , b ∈ {\{ 0.1 \}}^{N / 1}} {‖ {[ {y}_{P}^{T} , {y}_{D}^{T} ]}^{T} - ( {[ P , f ( b ) ]}^{T} ⊗ {I}_{{N}_{r}} ) g ‖}_{2}^{2} + {σ}^{2} {‖ g ‖}_{2}^{2} - α {‖ b - {0.5}_{N} ‖}_{2}^{2}$$

a constraint is

$${{\sum }_{i ∈ ℱ ( j )}^{} {b}_{i} -}_{} {\sum }_{i ∈ {𝒩}_{c} ( j ) \backslash ℱ ( j )}^{} {b}_{i} \leq \vert ℱ ( j ) \vert - 1 , ∀ ℱ ( j ) ⊆ 𝒮 ( j ) , j = 1 , 2 , … , M$$

$${b}_{i} ∈ [ 0 , 1 ] , i = 1 , 2 , … , N ,$$

where α>0 denotes an introduced penalty factor, [symbol] (j) denotes a variable set involved in the j-th check equation, [symbol] (j) denotes a set of the subsets of [symbol] (j) that have odd cardinalities. For the convenience of the subsequent representation, based on the element correspondence rule, the first constraint is rewritten into the following matrix form:

Ab≥θ,

where

$$A ∈ ℝ {\sum }_{j = 1}^{M} {2}^{{\vert {𝒩}_{c} ( j ) \vert - 1}^{}} \times N$$

denotes a weight matrix, and

$$θ ∈ ℝ {\sum }_{j = 1}^{M} {2}^{{\vert {𝒩}_{c} ( j ) \vert - 1}^{}}$$

denotes a deviation matrix.

Further, in Step (1), an auxiliary variable

$$z ∈ ℝ {\sum }_{j = 1}^{M} {2}^{{\vert {𝒩}_{c} ( j ) \vert - 1}^{}} ,$$

a dual variable

$$η ∈ ℝ {\sum }_{j = 1}^{M} {2}^{{2}^{\vert {𝒩}_{c} ( j ) \vert - 1}}$$

and a penalty factor μ>0 are introduced, and the rewritten problem is solved based on an alternating direction method of multipliers (ADMM), and the n-th ADMM iteration includes the following steps.

(1.1) An intermediate variable V_{b}_{^{e-1}} is calculated as:

$${V}_{{b}^{n - 1}} = {[ {Y}_{P} , {Y}_{D} ] [ P , f ( {b}^{n - 1} ) ]}^{H} {( {[ P , f ( {b}^{n - 1} ) ] [ P , f ( {b}^{n - 1} ) ]}^{H} + {σ}^{2} {I}_{{N}_{i}} )}^{- 1}$$

(1.2) An intermediate variable Sⁿ⁻¹ is calculated as:

$${S}^{n - 1} = ( {λ}^{n - 1} {I}_{{N}_{t}} - {V}_{{b}^{n - 1}}^{H} {V}_{{b}^{n - 1}} ) f ( {b}^{n - 1} ) + {V}_{{b}^{n - 1}}^{H} {Y}_{D} ,$$

where

$${λ}^{n - 1} = {λ}_{m ax} ( {V}_{{b}^{n - 1}}^{H} {V}_{{b}^{n - 1}} ) ,$$

λₘₐₓ(⋅) denotes a maximum eigenvalue taking from the input matrix.

(1.3) For k=1, 2, . . . , Nₜ, t=1, 2, . . . , T_{D}, bit variables are updated in sequence according to the following formula:

$${b}_{{i}^{t , k , q}}^{n} = {\prod }_{[ 0 , 1 ]} ( \frac{μ {a}_{{i}^{t , k , q}}^{T} ( θ - {z}^{n - 1} - {η}^{n - 1} ) - {γ}_{{i}^{t , k , q}}^{n - 1} - α}{{μΛ}_{{i}^{t , k , q}} + {β}_{{i}^{t , k , q}}^{n - 1} - 2 α} ) , q = 1 , 2 , ⋯ , Q ,$$

where i^{t,k,q}≙Q[Nₜ(t−1)+k−1]+q,

$${a}_{{i}^{t , k , q}}^{T}$$

denotes an i^{t,k,q}-th column in a matrix A, Λᵢ_{^{t,k,q}} denotes an i^{t,k,q}-th diagonal element in the matrix A^{T}A, Π_{[0,1]}(⋅) denotes a projection of input elements onto an interval [0,1]. In addition, the solution of

$${β}_{{i}^{t , k , q}}^{n - 1} and {γ}_{{i}^{t , k , q}}^{n - 1}$$

are related to the modulation order, by taking a quadrature phase shift keying (QPSK) modulation as an example, in this situation of Q=2,

$${β}_{{i}^{t , k , q}}^{n - 1} and {γ}_{{i}^{t , k , q}}^{n - 1}$$

can be calculated according to the following formulas:

$${β}_{{i}^{t , k , 1}}^{n - 1} = 4 {λ}^{n - 1} , {γ}_{{i}^{t , k , 1}}^{n - 1} = 2 \sqrt{2} Re \{ {s}_{kt}^{n - 1} \} - 2 {λ}^{n - 1} ,$$

$${β}_{{i}^{t , k , 2}}^{n - 1} = 4 {λ}^{n - 1} , {γ}_{{i}^{t , k , 2}}^{n - 1} = 2 \sqrt{2} Im \{ {s}_{kt}^{n - 1} \} - 2 {λ}^{n - 1} ,$$

where

$${s}_{kt}^{n - 1}$$

denotes a (k,t)-th element of Sⁿ⁻¹, Re{⋅} denotes a real part taking from the input element, and Im{⋅} denotes an imaginary part taking from the input element.

(1.4) An auxiliary variable zⁿ is updated according a following formula:

$${z}^{n} = {\prod }_{{[ 0 , ∞ ]}^{{\sum }_{j = 1}^{M}}}^{{}_{2} \vert {𝒩}_{c} ( j ) \vert - 1} ( θ - A {b}^{2} - {η}^{n - 1} ) ,$$

where

$${\prod }_{{[ 0 , ∞ ]}^{{\sum }_{j = 1}^{M}}}^{{}_{2} \vert {𝒩}_{c} ( j ) \vert - 1}$$

(⋅) denotes a projection of each element of an input vector to an interval [0, ∞].

(1.5) A dual variable ηⁿ is updated according to a following formula:

$${η}^{n} = {η}^{n - 1} + A {b}^{n} + {z}^{n} - θ .$$

Further, in Step (2), the ADMM solution framework in claim 5 is deeply unfolded, the n-th ADMM iteration is in correspondence to the I-th neural network, and the penalty factors α, μ and λ are set as the trainable parameters

$${\{ {α}^{I} , {μ}^{I} , {λ}^{I} \}}_{l = 1}^{L} ,$$

L denotes the number of the layers of the network.

Further, in Step (3), the offline phase includes the following steps.

(3.1) Datasets required for training are generated, each set of data includes inputs P, Y_{P}, Y_{D}, G of the network and labels required for training, that is, an actual transmitting codeword b.

(3.2) A mean square error between an output b^{L} of the L-th neural network and a label b is taken as a loss function for training, the neural network is trained, and the trainable parameters are obtained.

Further, in Step (4), in the online phase, an output of each layer of the network is determined by the receiving terminal through utilizing a trained neural network, when check equations are satisfied, a processing is terminated in advance, otherwise, a determination corresponding to an output of the last layer of the network is output. More specifically, an output of the l-th layer of the network is determined based on a following formula:

$${\hat{b}}_{i} = \{ \begin{matrix}0 , & {b}_{i}^{l} < 0.5 \\ 1 , & {b}_{i}^{l} \geq 0.5\end{matrix} i = 1 , 2 , ⋯ , N .$$

In comparison with the prior arts, the present disclosure has the following advantages and benefit technical effects.
(1) In the present disclosure, a trainable joint channel estimation, detection and decoding method is provided for the URLLC-MIMO system, which avoids the performance loss and the error propagation caused by the module division and can significant improve the block error rate (BLER) performance of the system.
(2) In comparison with the traditional receiving method, in the present disclosure, the iterative interaction between different modules is avoided, the system latency is reduced and the signalling overheads are saved.

### BRIEF DESCRIPTION OF THE DRAWINGS

FIG. 1 illustrates a flow chart of a trainable joint channel estimation, detection and decoding method applicable to a URLLC-MIMO system provided by the present disclosure.

FIG. 2 illustrates a diagram of a network structure provided by the present disclosure.

FIG. 3 illustrates a schematic diagram showing results of a simulation experiment of the present disclosure provided in one embodiment.

### DETAILED DESCRIPTION OF THE EMBODIMENTS

The present disclosure is further described in detail below with reference to the accompanying drawings and specific implementations.

A trainable joint channel estimation, detection and decoding method applicable to a URLLC-MIMO system is provided in the present disclosure, which can significantly improve the BLER performance of the system, reduce the system latency and save the signaling overheads.

In order to better understand the above technical solutions, the above technical solutions will be described in detail below with reference to the accompanying drawings and specific implementations.

In order to verify the performance results of the trainable joint channel estimation, detection and decoding method applicable for the URLLC-MIMO system provided by the present disclosure, a URLLC-MIMO system simulation platform is required to be established. In the embodiment, it is assumed that Nₜ transmitting antennas and Nᵣ receiving antennas are configured in the URLLC-MIMO system, and the channel coefficient is kept constant within a transmission time slot of T_{P}+T_{D} symbols, where T_{P} denotes the number of pilot symbols, and T_{D} denotes the number of data symbols. In the data transmission phase, firstly, the information bits are encoded into an LDPC codeword b=[b₁, b₂, . . . , b_{N}]^{T} with a code length of N by the transmitting terminal. Let H∈[0,1]^{M×N} represent a binary check matrix of the LDPC code, where M denotes the number of the check nodes. Then, the codeword is mapped into modulation symbols x=[x₁, x₂, . . . , x_{N/Q}]^{T} by the transmitting terminal, and the modulation symbols are evenly allocated to N, transmitting antennas for transmission by utilizing the multi-stream multiplexing technology, where Q denotes a modulation order. The pilot matrix is recorded as P∈ [symbol] ^{N}^{ₜ}^{×T}^{_{P}}, and the data matrix is recorded as D∈ [symbol] ^{N}^{ₜ}^{×T}^{_{D}} where T_{D}=N/(Q×Nₜ), and the receiving signal can be represented as:

$$[ {Y}_{P} , {Y}_{D} ] = G [ P , D ] + N ,$$

where Y_{P}∈ [symbol] ^{N}^{ₜ}^{×T}^{ₚ} denotes a pilot receiving matrix, and Y_{D}∈ [symbol] ^{N}^{ₜ}^{×T}^{ₚ} denotes a data receiving matrix, G∈ [symbol] ^{N}^{ᵣ}^{×N}^{ₜ} denotes a Gaussian channel matrix, and each element in the Gaussian channel matrix is independently and identically distributed, and a mean value of the each element in the Gaussian channel matrix is 0 and a variance of the each element in the Gaussian channel matrix is 1, N∈ [symbol] ^{N}^{ᵣ}^{×(T}^{_{P}}^{+T}^{_{D)}} denotes an additive white Gaussian noise matrix, and each element in the additive while Gaussian noise matrix is independently and identically distributed, a mean value of the each element in the additive white Gaussian noise matrix is 0 and a variance of the each element in the additive while Gaussian noise matrix is σ². Given that the (k, t)-th element in D is in correspondence to a modulation symbol x_{N}_{ₜ}₍ₜ₋₁₎₊ₖ. In addition, for the convenience of the subsequent representation, D is recorded as f(b), and f(⋅) denotes a bit-symbol mapping function, and a vectorized form of Y_{P} is recoded as y_{P}, a vectorized form of Y_{D} is recorded as y_{D}, and a vectorized form of G is recorded as g.

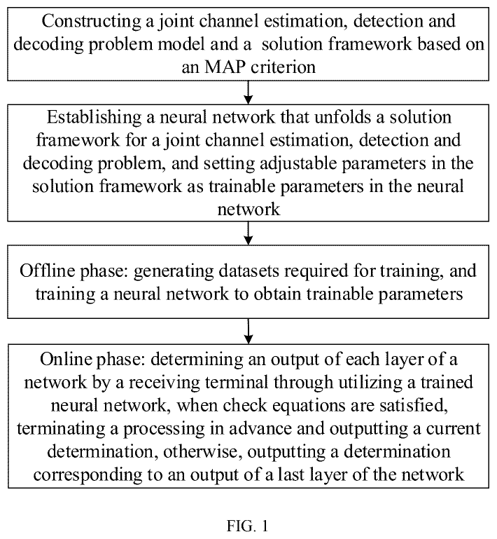

As illustrated in FIG. 1, the method is performed as the following steps.

In step (1), a joint channel estimation, detection and decoding problem model based on a maximum a posteriori (MAP) criterion is constructed as follows: the optimization object is

$${min}_{g ∈ {C}^{{N}_{r} {N}_{r} \times 1} , b ∈ {\{ 0 , 1 \}}^{N \times 1}} {‖ {[ {y}_{P}^{T} , {y}_{D}^{T} ]}^{T} - ( {[ P , f ( b ) ]}^{T} ⊗ {I}_{{N}_{r}} ) g ‖}_{2}^{2} + {σ}^{2} {‖ g ‖}_{2}^{2} ,$$

the constraint is

$${[ {\sum }_{i = 1}^{N} {H}_{ji} {b}_{i} ]}_{2} = 0 , j = 1 , 2 , ⋯ , M ,$$

$${b}_{i} ∈ \{ 0 , 1 \} , i = 1 , 2 , ⋯ , N ,$$

where [⋅]₂ denotes a modular-2 operator I_{N}_{_{P}} denotes an identity matrix with a dimension Nᵣ×Nᵣ, and Hⱼᵢ denotes the (j,i)-th element in the check matrix H of the LDPC code.

For the convenience of the solution, the original problem is rewritten into the following form: the optimization object is

$${min}_{g ∈ {C}^{{N}_{r} {N}_{t} \times 1} , b ∈ {\{ 0 , 1 \}}^{N \times 1}} {‖ {[ {y}_{P}^{T} , {y}_{D}^{T} ]}^{T} - ( {[ P , f ( b ) ]}^{T} ⊗ {I}_{{N}_{r}} ) g ‖}_{2}^{2} + {σ}^{2} {‖ g ‖}_{2}^{2} - α {‖ b - {0.5}_{N} ‖}_{2}^{2}$$

the constraint is

$${\sum }_{i ∈ ℱ ( j )} {b}_{i} - {\sum }_{i ∈ {𝒩}_{c} ( j ) \backslash ℱ ( j )} {b}_{i} \leq \vert ℱ ( j ) \vert - 1 , ∀ ℱ ( j ) ⊆ 𝒮 ( j ) , j = 1 , 2 , … , M ,$$

$${b}_{i} ∈ [ 0 , 1 ] , i = 1 , 2 , … , N ,$$

where α>0 denotes an introduced penalty factor, [symbol] (j) denotes a variable set involved in the j-th check equation, [symbol] (j) denotes a set of the subsets of [symbol] (j) that have odd cardinalities. For the convenience of the subsequent representation, based on the element correspondence rule, the first constraint is rewritten into the following matrix form:

$$Ab \geq θ ,$$

where

$$A ∈ ℝ {{{\sum }^{M}}_{j = 1}}^{{2}^{\vert {𝒩}_{c} ( j ) \vert - 1} \times N}$$

denotes a weight matrix, and

$$θ ∈ ℝ {{{\sum }^{M}}_{j = 1}}^{{2}^{\vert {𝒩}_{c} ( j ) \vert - 1}}$$

denotes a deviation matrix.

Subsequently, the auxiliary variable

$$z ∈ ℝ {{{\sum }^{M}}_{j = 1}}^{{2}^{\vert {𝒩}_{c} ( j ) \vert - 1}} ,$$

the dual variable

$$η ∈ ℝ {{{\sum }^{M}}_{j = 1}}^{{2}^{\vert {𝒩}_{c} ( j ) \vert - 1}}$$

and the penalty factor μ>0 are introduced, and the rewritten problem is solved based on the alternating direction method of multipliers (ADMM), and the n-th ADMM iteration includes the following steps.

(1.1) An intermediate variable V_{b}_{^{c-1}} is calculated as:

$${V}_{{b}^{n - 1}} = {[ {Y}_{P} , {Y}_{D} ] [ P , f ( {b}^{n - 1} ) ]}^{H} {( {[ P , f ( {b}^{n - 1} ) ] [ P , f ( {b}^{n - 1} ) ]}^{H} + {σ}^{2} {I}_{{N}_{t}} )}^{- 1} .$$

(1.2) An intermediate variable Sⁿ⁻¹ is calculated as:

$${S}^{n - 1} = ( {λ}^{n - 1} {I}_{{N}_{t}} - {V}_{{b}^{n - 1}}^{H} {V}_{{b}^{n - 1}} ) f ( {b}^{n - 1} ) + {V}_{{b}^{n - 1}}^{H} {Y}_{D} ,$$

where

$${λ}^{n - 1} = {λ}_{max} ( {V}_{{b}^{n - 1}}^{H} {V}_{{b}^{n - 1}} ) ,$$

λₘₐₓ(⋅) denotes a maximum eigenvalue taking from the input matrix.

(1.3) For k=1, 2, . . . , Nₜ, t=1, 2, . . . , T_{D}, the bit variables are updated in sequence according to the following formula:

$${b}_{{i}^{t , k , q}}^{n} = {\prod }_{[ 0 , 1 ]} ( \frac{μ {a}_{{i}^{t , k , q}}^{T} ( θ - {z}^{n - 1} - {η}^{n - 1} ) - {γ}_{{i}^{t , k , q}}^{n - 1} - α}{μ {Λ}_{{i}^{t , k , q}} + {β}_{{i}^{t , k , q}}^{n - 1} - 2 α} ) , q = 1 , 2 , … , Q ,$$

where i^{t,k,q}≙Q[Nₜ(t−1)+k−1]+q,

$${a}_{{i}^{t , k , q}}^{T}$$

denotes an i^{t,k,q}-th column in the matrix A, Λᵢ_{^{t,k,q}} denotes an i^{t,k,q}-th diagonal element in the matrix A^{T}A, Π_{[0,1]}(⋅) denotes the projection of input elements onto the interval [0,1]. In addition, in this embodiment, in consideration of quadrature phase shift keying (QPSK) modulation,

$${β}_{{i}^{t , k , q}}^{n - 1} and {γ}_{{i}^{t , k , q}}^{n - 1}$$

can be calculated according to the following formulas:

$${β}_{{i}^{t , k , 1}}^{n - 1} = 4 {λ}^{n - 1} , {γ}_{{i}^{t , k , 1}}^{n - 1} = 2 \sqrt{2} Re \{ {s}_{kt}^{n - 1} \} - 2 {λ}^{n - 1} ,$$

$${β}_{{i}^{t , k , 2}}^{n - 1} = 4 {λ}^{n - 1} , {γ}_{{i}^{t , k , 2}}^{n - 1} = 2 \sqrt{2} Im \{ {s}_{kt}^{n - 1} \} - 2 {λ}^{n - 1} ,$$

Under the 16-quadrature amplitude modulation (16QAM),

$${β}_{{i}^{t , k , q}}^{n - 1} and {γ}_{{i}^{t , k , q}}^{n - 1}$$

can be calculated according to the following formulas:

$$\text{?} = \frac{4}{5} {{λ}^{n - 1} ( 1 + 2 \text{?} )}^{2} , \text{?} = \frac{4}{\sqrt{10}} Re \{ {s}_{kt}^{n - 1} \} ( 1 + 2 \text{?} ) - \frac{2}{5} {{λ}^{n - 1} ( 1 + 2 \text{?} )}^{2} ,$$

$$\text{?} = \frac{4}{5} {{λ}^{n - 1} ( 1 + 2 \text{?} )}^{2} , \text{?} = \frac{4}{\sqrt{10}} Im \{ {s}_{kt}^{n - 1} \} ( 1 + 2 \text{?} ) - \frac{2}{5} {{λ}^{n - 1} ( 1 + 2 \text{?} )}^{2} ,$$

$$\text{?} = \frac{4}{5} {{λ}^{n - 1} ( 1 - 2 \text{?} )}^{2} , \text{?} = - \frac{4}{\sqrt{10}} Re \{ {s}_{kt}^{n - 1} \} ( 1 - 2 \text{?} ) + \frac{2}{5} {{λ}^{n - 1} ( 1 - 2 \text{?} )}^{2} ,$$

$$\text{?} = \frac{4}{5} {{λ}^{n - 1} ( 1 - 2 \text{?} )}^{2} , \text{?} = - \frac{4}{\sqrt{10}} Im \{ {s}_{kt}^{n - 1} \} ( 1 - 2 \text{?} ) + \frac{2}{5} {{λ}^{n - 1} ( 1 - 2 \text{?} )}^{2} ,$$

$$\text{?} \text{indicates text missing or illegible when filed}$$

where

$${s}_{kt}^{n - 1}$$

denotes a (k,t)-th element of Sⁿ⁻¹, Re{⋅} denotes a real part taking from the input element, and Im{⋅} denotes an imaginary part taking from the input element.

(1.4) The auxiliary variable zⁿ is updated according to the following formula:

$${z}^{n} = \text{?} ( θ - {Ab}^{n} - {η}^{n - 1} ) ,$$

$$\text{?} \text{indicates text missing or illegible when filed}$$

where

$$\text{?}$$

$$\text{?} \text{indicates text missing or illegible when filed}$$

denotes the projection of each element of the input vector to the interval [0, ∞].

(1.5) The dual variable ηⁿ is updated according to the following formula:

$${η}^{n} = {η}^{n - 1} + {Ab}^{n} + {z}^{n} - θ .$$

In Step (2), the ADMM solution framework is deeply unfolded, the n-th ADMM iteration is in correspondence to the l-th neural network, and the penalty factors α, μ and λ are set as the trainable parameters

$${\{ {α}^{l} , {μ}^{l} , {λ}^{l} \}}_{l = 1}^{L} ,$$

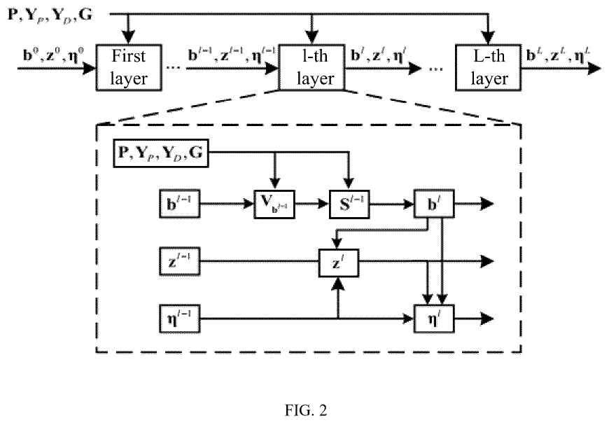

L denotes the number of the layers of the network. Specifically, the structure of the l-th neural network is as illustrated in FIG. 2.

In Step (3), the offline phase includes the following steps.

(3.1) The datasets required for training are generated, each set of the data includes the inputs P, Y_{P}, Y_{D}, G of the network and the labels required for training, that is, the actual transmitting codeword b.

(3.2) The mean square error between the output b^{L} of the L-th neural network and the label b is taken as the loss function for training, the neural network is trained and the trainable parameters are obtained.

In Step (4), in the online phase, the output of each layer of the network is determined by the receiving terminal through utilizing the trained neural network, when the check equations are satisfied, the processing is terminated in advance, and the current determination is output, otherwise, the determination corresponding to the output of the last layer of the network is output. More specifically, the output of the l-th layer of the network is determined based on the following formula:

$${\hat{b}}_{i} = \{ \begin{matrix}0 , & {b}_{i}^{l} < 0.5 \\ 1 , & {b}_{i}^{l} \geq 0.5\end{matrix} i = 1 , 2 , … , N .$$

In comparison with the MAP-Turbo receiver and the MMSE-Turbo receiver in consideration with the data-aided channel estimation in the traditional method, a simulation experiment is performed on this embodiment to evaluate the superiority of the present disclosure. The simulation parameters are as illustrated in the following table.

TABLE 1
Simulation Parameter Tabulation

| | | | |
|---|---|---|---|
| The number of the | 16 | Weights of row and | Row weight 3 |
| receiving antennas | | column of LDPC | column |
| Nᵣ | | | weight 6 |
| The number of the | 4 | Code length N of LDPC | 288 |
| transmitting antennas | | | |
| Nₜ | | | |
| The number of the pilot | 4 | The maximum number of | 100 |
| symbols | | layers of network | |
| T_{P} | | | |
| The number of the data | 36 | The maximum number of | 10 |
| symbols | | Turbo iterations | |
| T_{D} | | | |
| Modulation order | 2 | The maximum number of | 50 |
| Q | | belief propagation (BP) | |
| | | decoding iterations | |

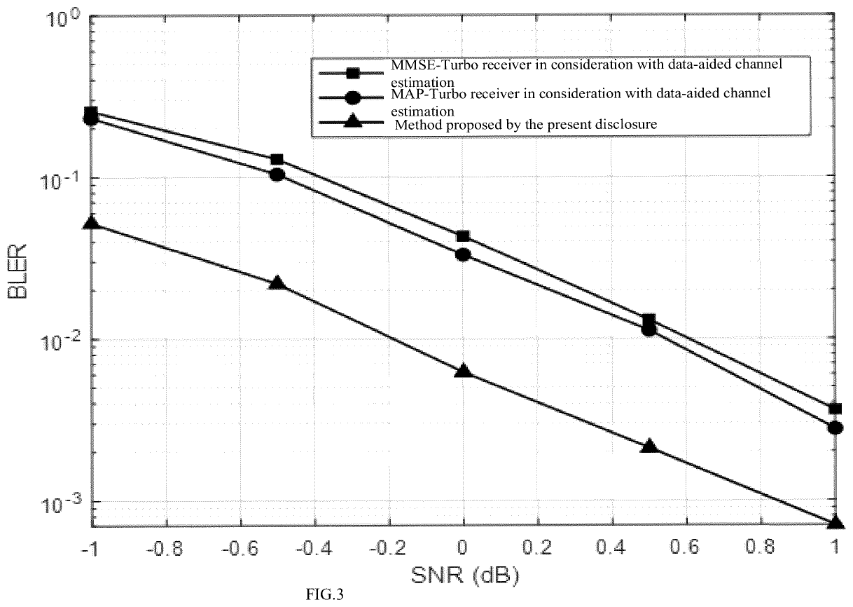

The horizontal axis SNR represents the signal-to-noise ratio, the vertical axis BLER represents the block error rate, and the simulation results of the above specific embodiments are as illustrated in FIG. 3. The simulation results show that, under the limited pilot overheads, the trainable joint channel estimation, detection and decoding method proposed in the present disclosure has a significant BLER performance advantage in comparison with the traditional MAP-Turbo receiver and MMSE-Turbo receiver in consideration with the data-aided channel estimation.

The above descriptions are merely the preferred embodiments of the present disclosure, which is not intended to limit the present disclosure in an arbitrary one of other form. An arbitrary modification or equivalent variation made based on the technical essence of the present disclosure still falls within the protection scope required by the present disclosure.

What is claimed is:

1. A trainable joint channel estimation, detection and decoding method applicable to a URLLC-MIMO system, comprising following steps:
S1, constructing, based on an MAP criterion, a joint channel estimation, detection and decoding problem model, as well as a solution framework;
S2, establishing a neural network that unfolds the solution framework for the joint channel estimation, detection and decoding problem, and setting adjustable parameters in the solution framework as trainable parameters of the neural network;
S3, in an offline phase, generating data sets required for training, and training the neural network, and obtaining the trainable parameters; and
S4, in an online phase, determining, by a receiving terminal, an output of each layer of a network through utilizing a trained neural network, terminating, when check equations are satisfied, a processing in advance, and outputting a current determination, otherwise, outputting a determination corresponding to an output of a last layer of the network.

2. The trainable joint channel estimation, detection and decoding method applicable to the URLLC-MIMO system according to claim 1, wherein before S1 is executed, the method further includes
configuring Nₜ transmitting antennas and Nᵣ receiving antennas in the URLLC-MIMO system, and keeping a channel coefficient be constant within a transmission time slot of T_{P}+T_{D} symbols, where T_{P} denotes a number of pilot symbols, and T_{D} denotes a number of data symbols; evenly allocating, after an LDPC codeword is mapped into modulation symbols, the modulation symbols to different transmitting antennas for transmitting in a data transmission phase.

3. The trainable joint channel estimation, detection and decoding method applicable to the URLLC-MIMO system according to claim 2, the evenly allocating, after an LDPC codeword is mapped into modulation symbols, the modulation symbols to different transmitting Antennas for transmitting specifically includes:
firstly encoding, by a transmitting terminal, information bits into an LDPC codeword b=[b₁, b₂, . . . b_{N}]^{T} with a code length of N, letting H∈[0,1]^{M×N} represents a binary check matrix of an LDPC code, where M denotes a number of the check nodes;
subsequently mapping, by the transmitting terminal, the codeword into modulation symbols x=[x₁, x₂, . . . , x_{N/Q}]^{T}, and evenly allocating, by utilizing a multi-stream multiplexing technology, the modulation symbols to Nₜ transmitting antennas for transmitting, where Q denotes a modulation order;
recording a pilot matrix as P∈ [symbol] ^{N}^{ₜ}^{×T}^{_{P}} and a data matrix as D∈ [symbol] ^{N}^{ₜ}^{×T}^{_{P}}, wherein T_{D}=N/(Q×Nₜ), and a receiving signal is represented as:
$$[ {Y}_{P} , {Y}_{D} ] = G [ P , D ] + N ,$$
where Y_{P}∈ [symbol] ^{N}^{ₜ}^{×T}^{_{P}} denotes a pilot receiving matrix, and Y_{D}∈ [symbol] ^{N}^{ₜ}^{×T}^{_{P}} denotes a data receiving matrix, G∈ [symbol] ^{N}^{ᵣ}^{×T}^{_{P}} denotes a Gaussian channel matrix, and each element in the Gaussian channel matrix is independently and identically distributed, and a mean value of the each element in the Gaussian channel matrix is 0 and a variance of the each element in the Gaussian channel matrix is 1, N∈ [symbol] ^{N}^{ᵣ}^{×(T}^{_{P}}^{+T}^{_{D}}⁾ denotes an additive white Gaussian noise matrix, and each element in the additive while Gaussian noise matrix is independently and identically distributed, a mean value of the each element in the additive white Gaussian noise matrix is 0 and a variance of the each element in the additive while Gaussian noise matrix is σ², recording, given that a (k, t)-th element in D is in correspondence to a modulation symbol x_{N}_{ₜ}₍ₜ₋₁₎₊ₖ, D as f(b), wherein f(⋅) denotes a bit-symbol mapping function.

4. The trainable joint channel estimation, detection and decoding method applicable to the URLLC-MIMO system according to claim 3, wherein in Step S1, a following joint channel estimation, detection and decoding problem model are constructed based on the MAP criterion,
an optimization object is:
$$\text{?} {‖ {[ {y}_{P}^{T} , {y}_{D}^{T} ]}^{T} - ( {[ P , f ( b ) ]}^{T} ⊗ \text{?} ) g ‖}_{2}^{2} + {σ}^{2} {‖ g ‖}_{2}^{2} ,$$
$$\text{?} \text{indicates text missing or illegible when filed}$$
a constraint is:
$${[ {\sum }_{i = 1}^{N} {H}_{ji} {b}_{i} ]}_{2} = 0 , j = 1 , 2 , … , M ,$$
$${b}_{i} ∈ \{ 0 , 1 \} , i = 1 , 2 , … , N ,$$
where [⋅]₂ denotes a modular-2 operator, y_{P} denotes a vectorized form of Y_{P}, y_{D} denotes a vectorized form of Y_{D}, g denotes a vectorized form of G, I_{N}_{ᵣ} denotes an identity matrix with a dimension Nᵣ×Nᵣ, and Hⱼᵢ denotes a (j,i)-th element in a check matrix H of the LDPC code.

5. The trainable joint channel estimation, detection and decoding method applicable to the URLLC-MIMO system according to claim 4, wherein in Step S1, an original problem is rewritten into a following form,
an optimization object is
$$\text{?} {‖ {[ {y}_{P}^{T} , {y}_{D}^{T} ]}^{T} - ( {[ P , f ( b ) ]}^{T} ⊗ \text{?} ) g ‖}_{2}^{2} + {σ}^{2} {‖ g ‖}_{2}^{2} - α {‖ b - {0.5}_{N} ‖}_{2}^{2} ,$$
$$\text{?} \text{indicates text missing or illegible when filed}$$
a constraint is
$$\text{?} {b}_{i} - \text{?} {b}_{i} \leq \vert ℱ ( j ) \vert - 1 , ∀ ℱ ( j ) ⊆ 𝒮 ( j ) , j = 1 , 2 , … , M ,$$
$${b}_{i} ∈ [ 0 , 1 ] , i = 1 , 2 , … , N ,$$
$$\text{?} \text{indicates text missing or illegible when filed}$$
where α>0 denotes an introduced penalty factor, [symbol] (j) denotes a variable set involved in a j-th check equation, [symbol] (j) denotes a set of subsets of [symbol] (j) that have odd potential cardinalities;
a first constraint is written into a following matrix form based on an element correspondence rule,
$$Ab \geq θ ,$$
where
$$A ∈ \text{?}$$
$$\text{?} \text{indicates text missing or illegible when filed}$$
denotes a weight matrix and
$$θ ∈ \text{?}$$
$$\text{?} \text{indicates text missing or illegible when filed}$$
denotes a deviation matrix.

6. The trainable joint channel estimation, detection and decoding method applicable to the URLLC-MIMO system according to claim 5, wherein in Step S1, an auxiliary variable
$$z ∈ \text{?} ,$$
$$\text{?} \text{indicates text missing or illegible when filed}$$
a dual parameter
$$η ∈ \text{?} ,$$
$$\text{?} \text{indicates text missing or illegible when filed}$$
and a penalty factor μ>0 are introduced, and the rewritten problem is solved based on an alternating direction method of multipliers (ADMM), wherein a n-th ADMM iteration includes following steps:
(1) calculating an intermediate variable V_{b}_{^{c-1}}:
$$\text{?} = {[ {Y}_{P} , {Y}_{D} ] [ P , f ( {b}^{n - 1} ) ]}^{H} {( {[ P , f ( {b}^{n - 1} ) ] [ P , f ( {b}^{n - 1} ) ]}^{H} + {σ}^{2} \text{?} )}^{- 1} ;$$
$$\text{?} \text{indicates text missing or illegible when filed}$$
(2) calculating an intermediate variable Sⁿ⁻¹:
$${S}^{n - 1} = ( {λ}^{n - 1} \text{?} - \text{?} ) f ( {b}^{n - 1} ) + \text{?} {Y}_{D} ,$$
$$\text{?} \text{indicates text missing or illegible when filed}$$
where
$${λ}^{n - 1} = {λ}_{max} ( \text{?} ) ,$$
$$\text{?} \text{indicates text missing or illegible when filed}$$
λₘₐₓ(⋅) denotes a maximum eigenvalue taking from an input matrix;
(3) for k=1, 2, . . . , Nₜ, t=1, 2, . . . , T_{D}, updating bit variables in sequence according to a following formula:
$$\text{?} = {\prod }_{[ 0 , 1 ]} ( \frac{μ \text{?} ( θ - {z}^{n - 1} - {η}^{n - 1} ) - \text{?} - α}{μ \text{?} + \text{?} - 2 α} ) , q = 1 , 2 , … , Q ,$$
$$\text{?} \text{indicates text missing or illegible when filed}$$
where
$$\text{?} \hat{=} Q [ {N}_{t} ( t - 1 ) + k - 1 ] + q , \text{?}$$
$$\text{?} \text{indicates text missing or illegible when filed}$$
denotes an i^{t,k,q}-th column in a matrix A, Λᵢ_{^{t,k,q}} denotes an i^{t,k,q}-th diagonal element in a matrix A^{T}A, Π_{[0,1]}(•) denotes a projection of input elements to an interval [0,1], and solutions of
$$\text{?} and \text{?}$$
$$\text{?} \text{indicates text missing or illegible when filed}$$
are related to the modulation order;
(4) updating an auxiliary variable z″ according to a following formula:
$${z}^{n} = \text{?} ( θ - {Ab}^{n} - {η}^{n - 1} )$$
$$\text{?} \text{indicates text missing or illegible when filed}$$
where
$$\text{?}$$
$$\text{?} \text{indicates text missing or illegible when filed}$$
(⋅) denotes a projection of each element of an input vector to an interval [0, ∞]; and
(5) updating a dual variable η″ according to a following formula:
$${η}^{n} = {η}^{n - 1} + {Ab}^{n} + {z}^{n} - θ .$$

7. The trainable joint channel estimation, detection and decoding method applicable to the URLLC-MIMO system according to claim 6, wherein when an quadrature phase shift keying (QPSK) is adopted, Q=2, and
$$\text{?} and \text{?}$$
$$\text{?} \text{indicates text missing or illegible when filed}$$
are calculated as following formulas:
$$\text{?} = 4 {λ}^{n - 1} , \text{?} = 2 \sqrt{2} Re \{ {s}_{kt}^{n - 1} \} - 2 {λ}^{n - 1} ,$$
$$\text{?} = 4 {λ}^{n - 1} , \text{?} = 2 \sqrt{2} Im \{ {s}_{kt}^{n - 1} \} - 2 {λ}^{n - 1} ,$$
$$\text{?} \text{indicates text missing or illegible when filed}$$
where
$${s}_{kt}^{n - 1}$$
denotes a (k,t)-th element of Sⁿ⁻¹, Re{⋅} denotes a real part taking from the input element, and Im{⋅} denotes an imaginary part taking from the input element.

8. The trainable joint channel estimation, detection and decoding method applicable to the URLLC-MIMO system according to claim 6, wherein in Step S2, the ADMM solution framework is deeply unfolded, the n-th ADMM iteration is in correspondence to a l-th layer of the neural network, and the penalty factors α, μ and λ are set as the trainable parameters
$${\{ {α}^{l} , {μ}^{l} , {λ}^{l} \}}_{l = 1}^{L} ,$$
where L denotes a number of layers of the network.

9. The trainable joint channel estimation, detection and decoding method applicable to the URLLC-MIMO system according to claim 8, wherein in Step S3, the offline phase includes following steps:
S301, generating datasets required for training, wherein each set of data includes inputs P, Y_{P}, Y_{D} and G of the network and labels required for training, that is, an actual transmitting codeword b; and
S302, taking a mean square error between an output b^{L} of the L-th neural network and a label b as a loss function for training, training the neural network, and obtaining the trainable parameters.

10. The trainable joint channel estimation, detection and decoding method applicable to the URLLC-MIMO system according to claim 9, wherein in Step S4, in the online phase, an output of each layer of the network is determined by the receiving terminal through utilizing a trained neural network, when check equations are satisfied, a processing is terminated in advance, otherwise, a determination corresponding to an output of a last layer of the network is output, wherein an output of the l-th layer of the network is determined based on a following formula:
$${\hat{b}}_{i} = \{ \begin{matrix}0 , & {b}_{i}^{l} < 0.5 \\ 1 , & {b}_{i}^{l} \geq 0.5\end{matrix} i = 1 , 2 , … , N .$$
